(19) United States
(12) Patent Application Publication
(10) Pub. No.: US 2024/0200747 A1
(43) Pub. Date: Jun. 20, 2024

(54) LIGHTING DEVICE FOR A VEHICLE, COMPRISING A TEXTURED FILM

(71) Applicant: VALEO VISION, Bobigny (FR)

(72) Inventors: Kostadin BEEV, Bobigny (FR); Christophe DUBOSC, Bobigny (FR); Thibaud BARILLOT, Bobigny (FR); Anthony LOZANO, Bobigny (FR); Stephanie BERGERAT, Bobigny (FR); Thomas DUFILS, Bobigny (FR)

(73) Assignee: VALEO VISION, Bobigny (FR)

(21) Appl. No.: 18/565,118

(22) PCT Filed: May 16, 2022
(86) PCT No.: PCT/EP2022/063176

§ 371 Date: Nov. 29, 2023

(30) Foreign Application Priority Data
May 31, 2021 (FR) FR2105692

(51) Int. Cl. F21S 41/50; F21S 41/20

(52) U.S. Cl. CPC F21S 41/50; F21S 41/285

(57) ABSTRACT

A lighting device for a vehicle, the lighting device being configured to perform at least one lighting function and including at least one optical module, an output lens and a housing including the at least one optical module, with the lighting device including a textured film covering a surface of the device, the textured film having patterns configured to reduce the transmission of light entering the lighting device through the surface.

### TECHNICAL FIELD

The present invention relates to a luminous device for a vehicle, said device being configured to perform at least one luminous function. The present invention is particularly, but non-limitingly, applicable to smart electric vehicles.

### BACKGROUND OF THE INVENTION

Smart electric vehicles require less space at the front for air intakes, but in contrast enhanced luminous functions are required for semi-autonomous or autonomous driving. Therefore, there is a growing interest in integrating “light” into large regions of the front and rear or sides of the vehicle, with a view to obtaining improved signaling and/or communication and to providing new large-area vehicle luminous functions. There is particularly demand for a signature line that is individually controllable with a view to performing a regulatory luminous function and/or an enhanced luminous function, and/or a styling function. In terms of style, manufacturers often require black opaque front or rear panels (called black panels) and the luminous device to be integrated into these panels so that, in off mode, elements inside the luminous device cannot be seen, and so that, in on mode, a better contrast is obtained in respect of said luminous function, in particular if the latter is an enhanced luminous function for communication with pedestrians, or a style feature such as a given luminous signature or a welcome scenario.

One example known to those skilled in the art of a vehicle luminous device configured to carry out at least one luminous function comprises:
at least one optical module comprising at least one light source, and
an outer lens, and
a housing containing said at least one optical module.

The outer lens is tinted and placed facing said optical module, said outer lens being configured to transmit a light beam resulting from light rays of said at least one light source of said light-emitting module to outside said vehicle and to stop ambient light originating from outside the vehicle so that it does not illuminate the elements inside the luminous device. Thus, in off mode, it is no longer possible to see the elements inside the luminous device.

In order to perform a regulatory luminous function, and/or an enhanced luminous function, and/or a styling function, said at least one light source is activated or various light sources are activated selectively or at the same time.

One drawback of this prior art is that such a luminous device degrades the one or more luminous functions performed by the luminous device. Specifically, in on mode the tinted outer lens only transmits between 10%-20% of the light beam to outside so as to achieve a black-panel effect allowing the elements inside the vehicle to be satisfactorily hidden in most cases from observation from outside the vehicle.

### BRIEF SUMMARY OF THE INVENTION

In this context, the present invention aims to provide a luminous device that allows the aforementioned drawback to be overcome.

To this end, the invention provides a luminous device for a vehicle, said luminous device being configured to perform at least one luminous function and comprising at least one optical module, an outer lens and a housing containing said at least one optical module, characterized in that said luminous device comprises a textured film covering a surface of said luminous device, said textured film comprising patterns configured to reduce the transmission of light entering into said luminous device through said surface.

Thus, as will be seen in detail below, the luminous device allows these limitations to be overcome (it maximizes the black-panel effect to hide the elements inside the vehicle without significantly impacting the transmission of the light beam generated by the luminous device).

According to non-limiting embodiments, said luminous device may furthermore comprise one or more of the following additional patterns, implemented alone or in any technically possible combination.

According to one non-limiting embodiment, said surface is covered in whole or in part by said textured film.

According to one non-limiting embodiment, said surface is a face of said outer lens.

According to one non-limiting embodiment, said surface is a face of an intermediate element placed between said optical module and said outer lens.

According to one non-limiting embodiment, said patterns are surface patterns or volume patterns.

According to one non-limiting embodiment, said surface patterns are produced using an IML or IMD process.

According to one non-limiting embodiment, when said patterns are surface patterns, they are formed by an ink deposit with a thickness of between 1 and 10 microns.

According to one non-limiting embodiment, said patterns are occulting or semi-transparent.

According to one non-limiting embodiment, said luminous device further comprises a mask.

According to one non-limiting embodiment, said luminous function is an illuminating function, a signaling function, a styling luminous function, or an enhanced luminous function.

According to one non-limiting embodiment, said patterns are continuous lines or punctual patterns.

According to one non-limiting embodiment, there is a pitch between said patterns and said pitch has a maximum value of 0.8 mm between the center of two patterns.

According to one non-limiting embodiment, said surface comprising said textured film is configured to transmit light variably.

According to one non-limiting embodiment, said patterns are arranged so that there is a variable pitch between said patterns and/or so that the patterns have a variable material density and/or so that there is a variable area between the patterns.

According to one non-limiting embodiment, said patterns form a negative image of punctual patterns, said punctual patterns being substantially transparent.

According to one non-limiting embodiment, said surface comprising said textured film is configured to transmit light variably.

According to one non-limiting embodiment, said punctual patterns are arranged so that there is a variable pitch between said punctual patterns and/or so that the punctual patterns have a variable area.

According to one non-limiting embodiment, the negative image comprises different areas with different material densities.

### BRIEF DESCRIPTION OF THE DRAWINGS

The invention and the various applications thereof will be better understood on reading the following description and studying the accompanying figures, in which:

FIG. 1 is a schematic view of a luminous device for a vehicle, said luminous device comprising an optical module, a housing, an outer lens, and a film textured with patterns on a surface of said luminous device, according to one non-limiting embodiment of the invention,

FIG. 2 is a schematic profile view of the surface of said luminous device of FIG. 1, said film textured with patterns being placed on a surface of said luminous device that belongs to said outer lens, according to a first non-limiting embodiment,

FIG. 3 is a schematic profile view of the surface of said luminous device of FIG. 1, said film textured with patterns being placed on a surface of said luminous device that belongs to an intermediate element between said outer lens and said optical module, according to a second non-limiting embodiment,

FIG. 4 is a schematic profile view of the surface of said luminous device of FIG. 1, said surface being covered with a film textured with surface patterns according to a first variant of a first non-limiting embodiment,

FIG. 5 is a schematic front view of said surface of FIG. 4,

FIG. 6 is a schematic profile view of the surface of said luminous device of FIG. 1, said surface being covered with a film textured with surface patterns according to a second variant of a first non-limiting embodiment,

FIG. 7 is a schematic front view of said surface of FIG. 6,

FIG. 8 is a schematic front view of the surface of said luminous device of FIG. 1, said surface being covered with a film textured with surface patterns according to a second non-limiting embodiment,

FIG. 9 is a schematic profile view of the surface of said luminous device of FIG. 1, said surface being covered with a film textured with volume patterns, according to a first variant of one non-limiting embodiment,

FIG. 10 is a schematic perspective view of said surface of FIG. 9,

FIG. 11 is a schematic profile view of the surface of said luminous device of FIG. 1, said surface being covered with a film textured with volume patterns, according to a second variant of one non-limiting embodiment,

FIG. 12 is a graph illustrating a difference in the transmission of the surface as a function of a vertical angle of incidence and of a horizontal angle of incidence of light incident on the surface of FIG. 9 or of FIG. 11, according to one non-limiting embodiment,

FIG. 13 is a schematic view of a film textured with volume patterns along a vehicle axis, with a vertical angle of incidence of the light incident on the surface of FIG. 9 or FIG. 11 of zero,

FIG. 14 is a schematic view of a film textured with volume patterns along a vehicle axis, with a vertical angle of incidence of the light incident on the surface of FIG. 9 or FIG. 11 of 20°,

FIG. 15 is a schematic view of a film textured with volume patterns along a vehicle axis, with a vertical angle of incidence of the light incident on the surface of FIG. 9 or FIG. 11 of 40°,

FIG. 16 is a schematic view of the screen of said luminous device according to any one of FIGS. 1 to 11, observed by an observer outside the vehicle, at two different observation angles, according to one non-limiting embodiment,

FIG. 17 is a graph of curves of the contrast sensitivity of an eye of an observer observing said luminous device according to one of FIGS. 1 to 11 from outside the vehicle,

FIG. 18 is a schematic front view of the surface of said luminous device of FIG. 1, said surface being covered with a film textured with surface patterns according to a third non-limiting embodiment.

Elements that are identical in terms of structure or function and that appear in various figures retain the same references, unless indicated otherwise.

### DETAILED DESCRIPTION OF THE INVENTION

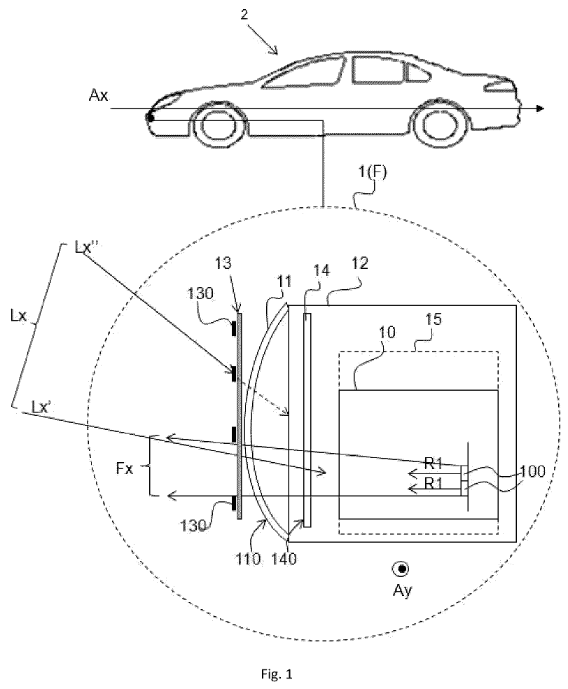

The luminous device 1 for a vehicle 2 according to the invention will now be described with reference to FIGS. 1 to 17. In one non-limiting embodiment, the vehicle 2 is a motor vehicle. A motor vehicle is understood to mean any type of motorized vehicle. This embodiment is taken as a non-limiting example throughout the remainder of the description. In the remainder of the description, the vehicle 2 is thus also called the motor vehicle 2. In one non-limiting variant of embodiment, the vehicle 2 is a semi-autonomous or autonomous electric vehicle.

The luminous device 1 is configured to perform at least one luminous function F. The luminous function F is either regulatory or not. Thus, in non-limiting embodiments, said at least one luminous function F is a regulatory function (such as an illuminating function or a signaling function), or a styling luminous function, or an enhanced luminous function (for communicating with pedestrians for example). In non-limiting examples, the illuminating function is a high beam or a low beam. In non-limiting examples, the signaling function is a daytime running light (DRL), a parking light (PL), a taillight (T), a turn indicator (TI), a side marker (SM), a stop light (STP), a reverse light (R), a fog light (FG), or a center high-mount stop light (CHMSL). In non-limiting examples, the styling luminous function is a luminous signature, a welcome scenario, a decorative luminous function, or a side luminous display function. In one non-limiting example, the enhanced luminous function is a function for displaying a pictogram. In one non-limiting embodiment, the luminous device 1 is configured to perform a plurality of luminous functions F. The luminous device 1 may be integrated into the front, into the rear or into the sides of the motor vehicle 2.

As illustrated in FIG. 1, the luminous device 1 of the vehicle 2 comprises:
at least one optical module 10 with at least one light source 100,
an outer lens 11, and
a housing 12 comprising said at least one optical module 10.

In the non-limiting example illustrated, the luminous device 1 comprises a single optical module 10. In one non-limiting embodiment, the luminous device 1 further comprises a mask 15. The mask 15 encircles the optical module 10. In FIG. 1 it has been illustrated by dotted lines because it extends along an axis Ay perpendicular to the vehicle axis Ax. The mask 15 that encircles the optical module 10 is a decorative mask. It is also called a bezel.

In one non-limiting embodiment, said optical module 10 comprises a plurality of light sources 100. This non-limiting embodiment will be considered, by way of non-limiting example, in the remainder of the description. In FIG. 1, only two light sources 100 have been shown.

The optical module 10 generates, by virtue of the light sources 100, a light beam Fx that is transmitted in the direction of the outer lens 11 toward outside the motor vehicle 2. A light source 100 emits light. It is thus configured to emit light rays R1 (illustrated in FIG. 1) to form said light beam Fx. When there is a plurality of light sources 100, the latter may be selectively activatable or may be activated at the same time. Thus, they may be switched on independently of one another. This allows perception of the desired luminous function F to be reinforced. In the non-limiting example of FIG. 1, when the luminous device 1 is placed at the front or rear of the motor vehicle 2, the light rays R1 are mostly transmitted in the direction of the vehicle axis Ax or in the opposite direction to the vehicle axis Ax, respectively. In another non-limiting example (not illustrated), when the luminous device 1 is placed on a side of the motor vehicle 2, the light rays R1 are mostly transmitted in a direction perpendicular to the vehicle axis Ax, in the direction of the axis Ay or in the opposite direction to the axis Ay.

In one non-limiting embodiment, the light sources 100 are semi-conductor light sources. In one non-limiting embodiment, a semiconductor light source forms part of a light-emitting diode. By light-emitting diode, what is meant is any type of light-emitting diode, such as, to give non-limiting examples, conventional LEDs (Light-Emitting Diodes), OLEDs (Organic LEDs), AMOLEDs (Active-Matrix-Organic LEDs), FOLEDs (Flexible OLEDs), RGB diodes or multi-chip diodes.

As illustrated in FIG. 1, the luminous device 1 comprises a textured film 13, which covers one of its surfaces 110, 140. The surface 110, 140 is covered in whole or in part by the textured film 13. It will be noted that FIG. 1 is an exploded view of the luminous device 1. Thus, the textured film 13 has been shown at a distance from the two surfaces 110, 140. The surface 110, 140 is covered in whole or in part by the textured film 13. In the non-limiting example illustrated in FIG. 5, the surface 110, 140 is partially covered, whereas in the non-limiting example illustrated in FIG. 7, the surface 110, 140 is completely covered.

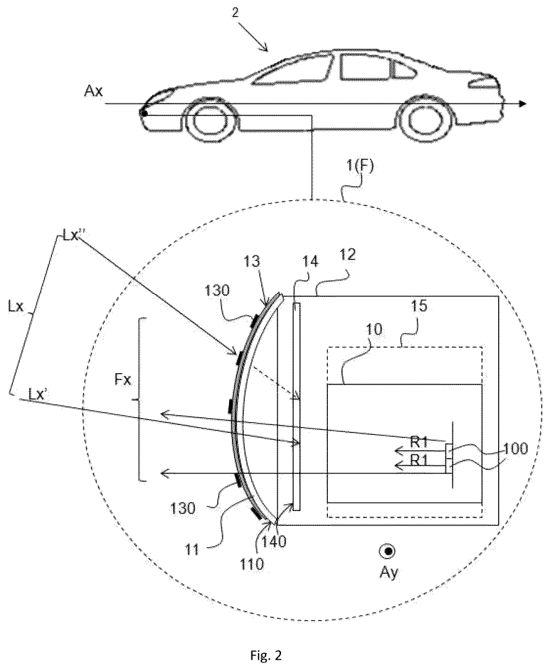

In a first non-limiting embodiment illustrated in FIG. 2, the surface 110 that is covered with the textured film 13 is the inside face or outside face of the outer lens 11. The outer lens 11 possesses a curved surface 110.

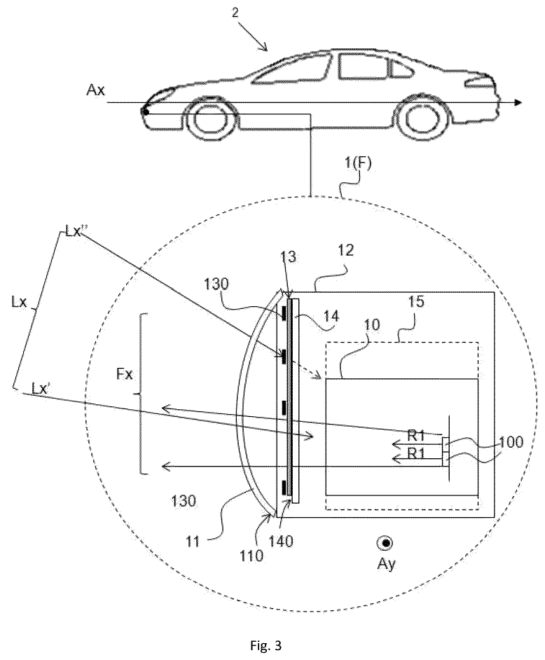

In a second non-limiting embodiment illustrated in FIG. 3, the surface 140 that is covered with the textured film 13 is one of the faces of an intermediate element 14 placed between the optical module 10 and the outer lens 11. The face may be the face facing the outer lens 11 or the face facing the optical module 10. The intermediate element comprises a planar surface 140. The advantage thereof is that it facilitates application of the textured film 13, with respect to a curved surface. This is advantageous when the texture is a volume texture, namely when the film 13 is textured with volume patterns 130. This facilitates application with respect to a curved surface, which may deform the volume patterns 130, especially if its curvature is great.

When the outer lens 11 or the intermediate element 14 are only covered in part by the textured film 13, one portion of the surface 110, 140 thereof is thus devoid of patterns 130.

The textured film 13 comprises patterns 130 configured to reduce the transmission of light Lx entering into said luminous device 1. This light Lx is ambient light originating from outside the motor vehicle 2. The patterns 130 are occulting or semi-transparent with a variable level of transparency.

By occulting, what is meant is that the patterns 130 allow only between 0% and 20% of the light Lx to pass. By semi-transparent, what is meant is that the patterns 130 allow only between 20% and 90% of the light Lx to pass.

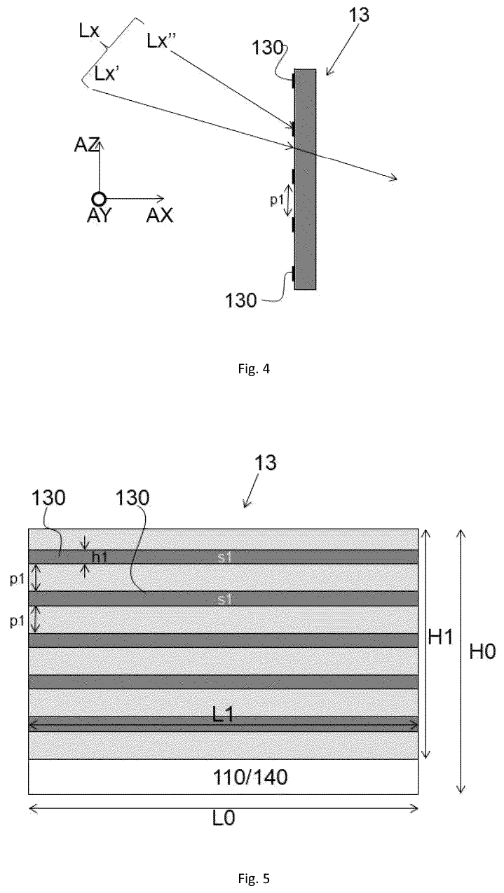

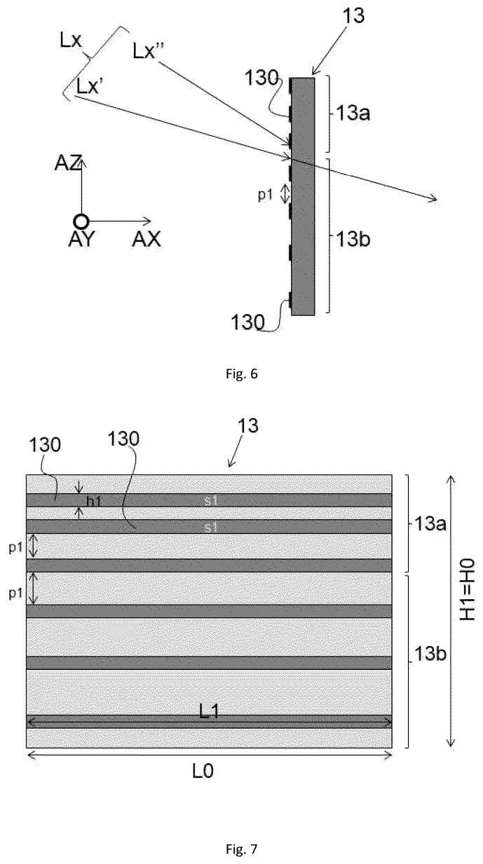

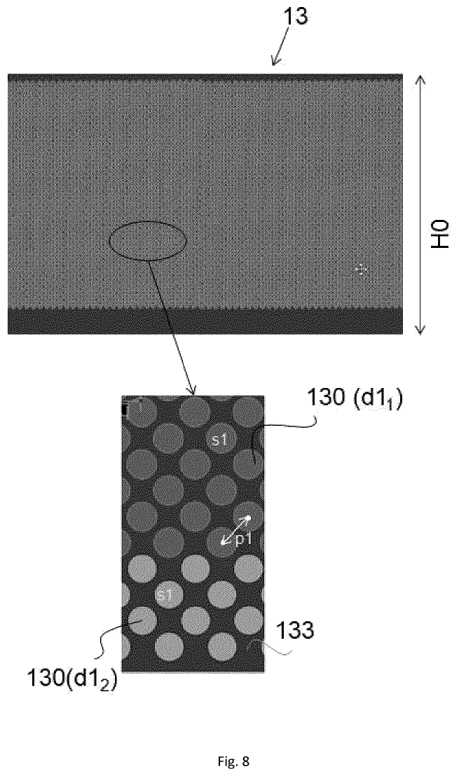

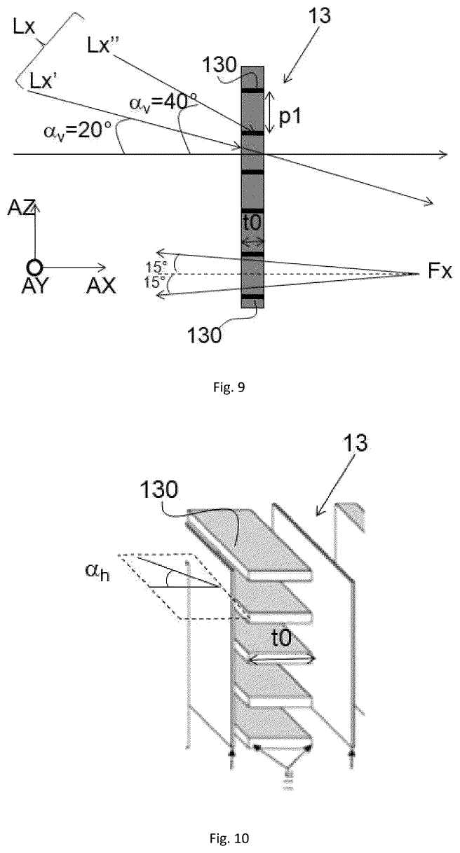

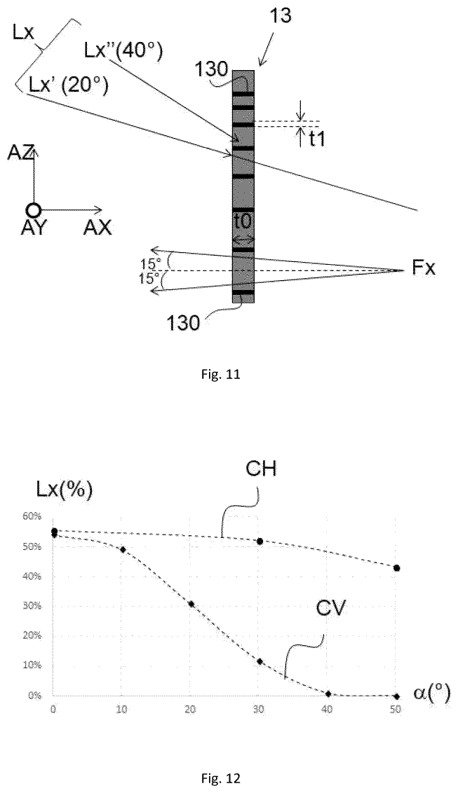

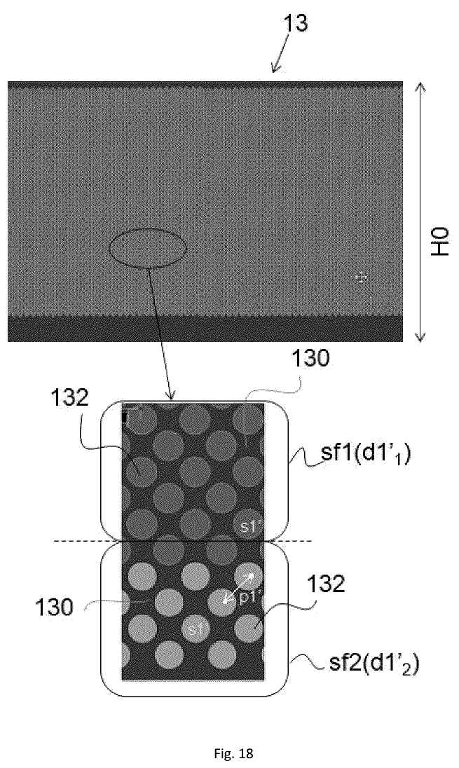

In non-limiting embodiments, said patterns 130 are continuous lines (as illustrated in FIG. 4, FIG. 5, FIG. 6, FIG. 7, FIG. 9, FIG. 10, and FIG. 11), also called texture lines, or punctual patterns (as illustrated in FIG. 8). In another non-limiting embodiment, said patterns 130 form a negative image of punctual patterns 132 (as illustrated in FIG. 18).

When the light Lx strikes the surface 110 or 140 covered with the textured film 13, a part Lx′ will pass through said surface 110 or 140 while a part Lx″ will be wholly or partially stopped by one or more patterns 130 of the textured film 13, as illustrated in FIG. 1, FIG. 2, and FIG. 3. The patterns 130 thus allow the transmission of the light Lx entering into the luminous device 1 to be reduced.

It will be noted that luminous functions F such as regulatory functions F must cover a vertical range of +/−15°. The emission cone of the light beam Fx is very restricted vertically, it is in total 30°, while horizontally it is in total 125° for certain functions. Therefore, the light beam Fx passes through the surface 110, 140 comprising the patterns 130, but the patterns 130 are arranged with respect to one another so as not to significantly impede transmission of said light beam Fx to outside in the various described embodiments.

In a first non-limiting embodiment illustrated in FIGS. 4 to 8 and 18, the patterns 130 are surface patterns. These are either continuous lines (defined by an area s1), or punctual patterns (defined by an area s1), or a negative image of punctual patterns 132.

When the surface patterns 130 are continuous lines as illustrated in FIGS. 4 to 7, in one non-limiting embodiment, the patterns 130 extend along the length L0 of the surface 110, 140. They are thus defined by a length L1 smaller than or equal to the length L0 of the surface 110, 140 and by a height h1. In the non-limiting examples of FIGS. 5 and 7, L1=L0. Considered as a whole, the textured surface composed of the surface patterns 130 may have a height H1 less than or equal to the height H0 of the surface 110, 140. In the non-limiting example of FIG. 5, H1<H0. In the non-limiting example of FIG. 7, H1=H0.

The continuous lines 130 may have equal or different areas s1. Thus, they may have the same height h1 or different heights h1 and/or equal or different lengths L1. In one illustrated non-limiting embodiment, the patterns 130 have the same length L1. In one non-limiting mode, the height h1 of a continuous line is comprised between 0.2 mm and 0.5 mm.

When the surface patterns 130 are punctual patterns as illustrated in FIG. 8, in one non-limiting example, they are dots that are defined by their area s1. The punctual patterns 130 may have equal or different areas s1. In one non-limiting embodiment, the area s1 is comprised between 0.25 mm2 and 0.75 mm2. In one non-limiting example, the density of the punctual patterns 130 is 50% with respect to the total area of the textured film 13. The textured film 13 is formed of punctual patterns 130 and of a negative image 132 of the punctual patterns 130. The punctual patterns 130 are opaque or semi-transparent and reduce the transmission of the light Lx, while the negative image 133 is substantially transparent. It thus lets the light Lx pass through. The negative image 133 represents the remainder of the effective area of the textured film 130.

When the surface patterns 130 are a negative image of punctual patterns 132 as illustrated in FIG. 18, the negative image 130 of said punctual patterns 132 represents the remainder of the effective area of the textured film 130. The negative image 130 is opaque or semi-transparent and reduces the transmission of the light Lx while the punctual patterns 132 for their part are substantially transparent. They thus let the light Lx pass through.

As illustrated in FIGS. 5, 7 and 8, the patterns 130 are spaced apart by a pitch p1. The pitch p1 may be constant or variable. In the case of FIG. 8, the pitch p1 is the distance between the center of the patterns 130. As illustrated in FIG. 18, the punctual patterns 132 are spaced apart by a pitch p1′. The pitch p1′ may be constant or variable. In the case of FIG. 18, the pitch p1′ is the distance between the center of the punctual patterns 132.

In a first non-limiting variant of embodiment illustrated in FIGS. 4, 5, 8 and 18, the surface 110, 140 transmits the light Lx constantly (as opposed to having a transmission that varies as a function of height up the surface 110, 140) considering the surface 110, 140 in its entirety. In this case, in the example of FIGS. 4, 5 and 8, the pitch p1 between the patterns 130 remains constant, and the material density d1 of the patterns 130 remains constant, and the area s1 between the patterns 130 remains constant. Thus d11=d12 in the non-limiting example illustrated in FIG. 8. In this case, in the example of FIG. 18, the pitch p1′ between the punctual patterns 132 remains constant, and the area s1′ between the punctual patterns 132 remains constant, and the material density d1′ of the negative image 130 remains constant in all the areas sf making up said negative image 130.

In a second non-limiting variant of embodiment, the surface 110, 140 transmits the light Lx variably in the direction of its height H0. The top portion 13a of the textured film 13 will be more occulting than the bottom portion 13b. Transmittance will be higher in front of the optical module 10 in order to allow the light beam Fx to be transmitted out of the luminous device 1, and transmittance will decrease gradually with height H0 up the surface 110, 140. The greater the height, the lower the transmittance.

When the patterns 130 are continuous lines or punctual patterns, in one non-limiting embodiment, the surface 110, 140 transmits the light Lx variably as a result of arranging said patterns 130 so that the patterns 130 have a variable material density d1 and/or so that there is a variable pitch p1 between the patterns 130 and/or so that the patterns 130 have a variable area s1.

When the patterns 130 are a negative image of punctual patterns 132, in another non-limiting embodiment, the surface 110, 140 transmits the light Lx variably as a result of arranging said punctual patterns 132 so that the punctual patterns 132 have a variable pitch p1′ and/or so that there is a variable area s1′ between the punctual patterns 132, or as a result of arranging various areas sf of said negative image 130 to have different material densities d1′.

Thus, to make the patterns 130 relatively dense in the material thereof, in one non-limiting embodiment, the thickness or density of an ink deposit that is used to produce said patterns 130 may be varied. It will be noted that when the material density d1 of the patterns 130 (punctual patterns 130 or continuous lines 130) or the material density d1′ of various areas sf of the negative image 130 is varied, the transmission of light varies. Certain patterns 130 (punctual patterns 130 or continuous lines 130) or one or more areas sf of the negative image 130 may be completely occulting, while others may be semi-transparent. In the non-limiting example illustrated in FIG. 8, for example, some patterns 130 thus have a material density d11 denser than other patterns of material density d12. In the non-limiting example illustrated in FIG. 18, for example, the area sf1 thus has a material density d1′1 denser than the area sf2 of material density d1′2. The denser the material density d1 or d1′, the lower the transmission of the light Lx will be. Thus, the patterns 130 (punctual patterns 130 or continuous lines 130) or the areas sf of the negative image 130 located in the top portion 13a of the textured film 13 (and therefore toward the top of the surface 110, 140) will have a material density d1 or d1′ that is higher, so as to make the top portion 13a more occulting, than that of the patterns 130 (punctual patterns 130 or continuous lines 130) or areas sf of the negative image 130 located in the bottom portion 13b of the textured film 13 (and therefore toward the bottom of the surface 110, 140), so as to make the bottom portion 13b less occulting.

Thus, in one non-limiting embodiment, the patterns 130 are arranged so that groups of patterns 130 have variable areas s1, a group of patterns 130 comprising one or more patterns 130. Thus, the patterns 130 located in the top portion 13a of the textured film 13 (and therefore toward the top of the surface 110, 140) will have an area s1 that is larger, so as to make the top portion 13a more occulting, than that of the patterns 130 located in the bottom portion 13b of the textured film 13 (and therefore toward the bottom of the surface 110, 140), so as to make the bottom portion 13b less occulting.

Thus, in one non-limiting embodiment, the punctual patterns 132 are arranged so that groups of punctual patterns 132 have variable areas s1′, a group of punctual patterns 132 comprising one or more punctual patterns 132. Thus, the punctual patterns 132 located in the top portion 13a of the textured film 13 (and therefore toward the top of the surface 110, 140) will have an area s1′ that is smaller, so as to make the top portion 13a more occulting, than that of the punctual patterns 132 located in the bottom portion 13b of the textured film 13 (and therefore toward the bottom of the surface 110, 140), so as to make the bottom portion 13b less occulting.

Thus, in one non-limiting embodiment, the patterns 130 are arranged so that there is a variable pitch p1 therebetween. In one non-limiting example, the pitch p1 varies from 0.5 mm to 5 mm. In one non-limiting example, the pitch p1 has a maximum value of 0.8 mm between the center of two patterns 130. 0.8 mm corresponds to an object of an angular size of 0.9 arcmin, i.e. of less than 1 arcmin, located at an observation distance of 3 meters. The further below 0.8 mm the pitch gets, the smaller the angular size of a feature 130. Below an angular size of 1 arcmin, the eye can no longer distinguish the patterns 130. In the non-limiting example of FIGS. 6 and 7, it is the pitch p1 that is adjusted. The pitch p1 is smaller in the upper portion 13a of the textured film 13, in order to obtain patterns 130 that are closer to one another so as to make the top portion 13a of the textured film 13 more occulting, than in the bottom portion 13b where the pitch p1 is larger, so as to make the bottom portion 13b less occulting. The same principle may be applied to the punctual patterns 132 of the case of FIG. 18. If the pitch p1′ is larger, then the punctual patterns 132 are more spaced out, this further decreasing the transmission of the light Lx. The pitch p1′ is thus larger in the top portion 13a of the textured film 13, in order to obtain punctual patterns 132 that are further apart from one another so as to make the top portion 13a of the textured film 13 more occulting, than in the bottom portion 13b where the pitch p1′ is smaller, so as to make the bottom portion 13b less occulting.

In one non-limiting embodiment, the surface patterns 130 are produced using an IML process (IML standing for in-mold labelling) or an IMD process (IMD standing for in-mold decorating). In these methods, an ink is deposited on a film in order to produce the patterns 130 and thus add the texture to said film. In one non-limiting embodiment, the ink deposit possesses a thickness comprised between 1 and 10 microns.

In a second non-limiting embodiment illustrated in FIGS. 9 to 11, the patterns 130 are volume patterns. They lie in the thickness of the textured film 130. In this case, the patterns 130 have a depth t0 and a pitch p1 therebetween. The depth t0 and the pitch p1 are defined so as not to cut off the light beam Fx generated by the optical module 10. In one non-limiting embodiment, the depth t0 is comprised between 0.03 mm and 0.15 mm. In one non-limiting embodiment, the pitch p1 between the volume patterns 130 is smaller than or equal to 0.04 mm. In this case the volume patterns 130 are not visible by an outside observer at any observation distance. In FIG. 10, the volume patterns 130 are parallelepipedal in shape. It will be noted that the volume patterns 130 may also be cylindrical in shape. In this case, to see what they would look like seen from the front, reference may be made to FIG. 8.

FIG. 12 illustrates a graph of the transmission of the light Lx in % as a function of the angle of incidence α in degrees of the light Lx originating from outside the vehicle 2 and incident on the surface 110, 140 of the luminous device 1. The light Lx possesses an angle of incidence a that may be decomposed into a horizontal angle of incidence ah illustrated in FIG. 10 and into a vertical angle of incidence αv illustrated in FIG. 9. The curve CH indicates the percentage transmission of the light Lx of horizontal angle of incidence ah, and the curve CV indicates the percentage transmission of the light Lx of vertical angle of incidence αv. From the curve CV, it may be seen that the more the vertical angle of incidence αv increases, the more the transmission of the light Lx is cut off. Whereas from the curve CH, it may be seen that as the horizontal angle of incidence ah increases, the transmission of the light Lx is not greatly attenuated. The small attenuation that may be seen is simply due to Fresnel reflections from the surface 110, 140.

The part Lx″ of the light Lx that will not be transmitted through the surface 110, 140 has a vertical angle of incidence αv of 400 or more. Thus, the patterns 130 cut off the light Lx beyond this angle of incidence α of 40°. Beyond this angle of incidence of 40°, the light Lx originating from outside is no longer able to enter into the luminous device 1.

It will be noted that luminous functions F such as regulatory functions F must cover a vertical range of +/−15°. The emission cone of the light beam Fx is very restricted vertically, it is in total 300, while horizontally it is in total 125° for certain functions. Thus, the light beam Fx passes through the surface 110, 140 comprising the patterns 130, because the patterns 130 are arranged with respect to one another so as to let said light beam Fx pass. In respect of volume patterns 130, it will be noted that the light beam Fx of regulatory functions F passes through the surface 110, 140 comprising the patterns 130 because the pitch p1 between the patterns 130 and the depth t0 of the patterns 130 are defined to let the light beam FX pass vertically. It is not stopped by the patterns 130. Thus, the light beam Fx generated by the optical module 10 is transmitted optimally to outside the luminous device 1.

In a first non-limiting variant of embodiment illustrated in FIGS. 9 and 10, the patterns 130 transmit the light Lx constantly (in contrast to variable transmission) considering the surface 110, 140 in its entirety. In this case, the pitch p1 between the patterns 130 remains constant.

In a second non-limiting variant of embodiment illustrated in FIG. 11, the patterns 130 transmit the light Lx variably. The top portion 13a of the textured film 13 will be more occulting than the bottom portion 13b.

To make the transmission variable, the pitch p1 between the patterns 130 and/or the thickness of the patterns t1 130 are adjusted. In the non-limiting example of FIG. 11, it is the pitch p1 that is adjusted. The pitch p1 is smaller in the top portion 13a of the textured film 13, in order to obtain patterns 130 that are closer to one another than in the bottom portion 13b where the pitch p1 is larger.

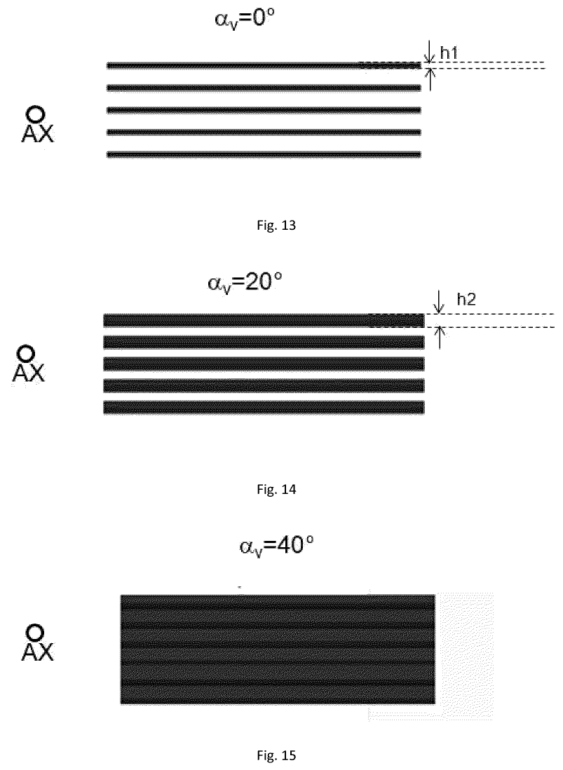

In FIG. 13, when the surface 110, 140 is observed from outside the vehicle and along the vehicle axis Ax, the height h1 of the patterns 130 may be seen but not their depth t0. If the light Lx strikes said surface 110, 140 (comprising the textured film 13 with the volume patterns 130) with a vertical angle of incidence αv of 0, then there is 55% transmission as indicated in the graph of FIG. 12; part of the light Lx is occulted by the patterns 130.

In FIG. 14, when the surface 110, 140 is observed from outside the vehicle at 200 with respect to the vehicle axis Ax, the height h1 of the patterns 130 and part of the depth t0 of the patterns may be seen, these together being reference h2 in FIG. 14. If the light Lx strikes said surface 110, 140 (comprising the textured film 13 with the volume patterns 130) with a vertical angle of incidence αv of 20°, then there is 30% transmission as indicated in the graph of FIG. 12; a large part of the light Lx is occulted by the patterns 130.

In FIG. 15, when the surface 110, 140 is observed from outside the vehicle and along the vehicle axis Ax, at a vertical angle of incidence αv larger than or equal to 40, the space between the patterns 130 is no longer seen. If the light Lx strikes said surface 110, 140 (comprising the textured film 13 with the volume patterns 130) with a vertical angle of incidence αv larger than or equal to 40°, then there is next to 0% transmission as indicated in the graph of FIG. 12; the light Lx is completely occulted by the patterns 130.

Thus it may be seen that, in all the embodiments presented above, transmission from outside the motor vehicle 2 to inside the luminous device 1 of the ambient light Lx originating from outside the motor vehicle 2 is greatly reduced, or even completely prevented, by virtue of the patterns 130.

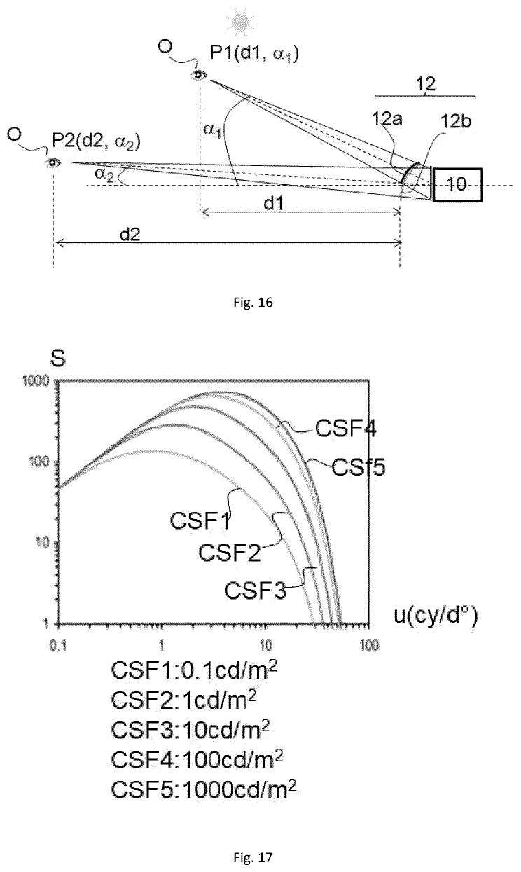

This means that, in off mode, when the optical module 10 is not activated, i.e. when there is no light beam Fx, an observer O, represented by an eye in FIG. 16, owing to the ambient illumination, which is referred to as ambient light Lx originating from outside the motor vehicle 2, is unable to see the optical module 10, the mask 15 or any other element of the luminous device 1 located behind the outer lens 11.

Without the patterns 130, when the observer O is close to the luminous device 1, the observer O is able to see the elements inside the luminous device 1, and in particular she or he will be able to distinguish between the optical module 10 and the mask 15. By close, what is meant is that the observer O is located between 1 meter and 3 meters from the motor vehicle 2 and therefore from the luminous device 1, this typically corresponding to an observation angle α comprised between 200 and 48°. It will be noted that the observation angle α is the angle between the horizontal straight line passing through the middle of the surface 110, 140 and the straight line passing through the eye of the observer O. In contrast, by virtue of the patterns 130, the surface 110, 140 incorporating the patterns 130 is partly occulting when the observer O is close to the luminous device 1. She or he will no longer be able to see elements inside the luminous device 1 in off mode. As illustrated in FIG. 16, the observer O when located in position P1, with a distance d1 from the luminous device 1 and an observation angle α1, is close to the luminous device 1.

The graph of Barten curves in FIG. 17 illustrates curves of contrast sensitivity CSF. Five curves CSF1 to CSF5 illustrating contrast sensitivities of the eye have been plotted in the graph, for five different light levels representing various luminances of adaptation of the eye, the five curves CSF1 to CSF5 having a ratio of 10 between one and the next. The curves CSF1 to CSF5 thus relate to respective sensitivity-threshold values S of 0.1, 1, 10, 100 and 1000 candela per m2 luminance of adaptation. The sensitivity threshold S is also referred to as the contrast sensitivity S. The spatial frequency u in cycles per degree (cpd) is plotted on the x-axis, and the sensitivity threshold 5, i.e. the inverse of the value of the lowest contrast detectable at the spatial frequency u in question, is plotted on the y-axis. The spatial frequency u corresponds to the angular size of the object observed by the eye. Thus, in one non-limiting example, if the optical module 10 is 10 mm in size, the angular size corresponds to a spatial frequency u of 1.7 cpd at a distance of 1 m. At 10 meters, the angular size corresponds to 17 cpd, and at 25 m, it corresponds to 43 cpd.

The smaller the distance to the motor vehicle 2 and therefore to the luminous device 1, the smaller the spatial frequency u becomes. Thus, in one non-limiting example, the spatial frequency u will pass from 5 cpd and 1.7 cpd for an object with a size of 10 mm. This corresponds to an observation angle α comprised between 20° and 48°. The relevant point thus shifts from right to left on the set of Barten curves as the luminous device 1 is approached. Thus, the smaller the spatial frequency u, the better the elements inside the luminous device 1 may be seen, i.e. the greater the contrast sensitivity S between the surface 110, 140 incorporating the patterns 130 and the elements inside the luminous device 1. In this case, the contrast sensitivity S of the eye increases.

Thus, the closer the observer O gets to the motor vehicle 2 and therefore to the luminous device 1, the more the contrast sensitivity S of the eye increases. She or he will therefore be able to clearly see the elements inside the luminous device 1 if there are no patterns 130 on the surface 110, 140. Her or his perception of the contrast between the elements inside the luminous device 1 will be good, this contrast representing a difference in luminance that may be expressed by (Lmax−Lmin)/(Lmax+Lmin) with Lmax the luminance of the optical module 10 in off mode and Lmin the luminance of the mask 15 in off mode in one non-limiting embodiment.

In order to make it so that the observer O when close to the luminous device 1 is unable to see the elements inside the luminous device 1, it is possible to adjust luminance level locally by decreasing local ambient light Lx on the surface 110, 140 of the luminous device 1. Thus, a CSF curve for a lower light level will be passed to from a CSF curve for a higher light level. The relevant point in the graph will thus move from right to left. By decreasing the amount of ambient light Lx, luminance level is decreased. Contrast sensitivity S is thus decreased. Thus, with the set of curves of FIG. 17, for a given spatial frequency u, for example 10 cpd, it may be seen that contrast sensitivity S decreases as the amount of local ambient light Lx decreases, i.e. the contrast between the elements inside the luminous device 1 (between the optical module 10 and the mask 15 in particular) through the surface 110, 140 will be less perceptible by eye, even though said contrast may be the same.

The local decrease in the amount of ambient light Lx is achieved by means of patterns 130 located on the surface 110, 140 according to the various embodiments described above. The surface 110, 140 which, by virtue of the patterns 130, is thus partially or completely occulting, will thus limit or decrease to zero the amount of ambient light Lx that enters into the luminous device 1.

In contrast, the larger the distance to the motor vehicle 2 and therefore to the luminous device 1, the more the spatial frequency u tends to increase beyond 10 cpd to as much as 60 cpd. This corresponds to an observation angle α approaching 0°. As illustrated in FIG. 16, the observer O when located in position P2, with a distance d2 larger than the distance d1 and an observation angle α2 smaller than the observation angle α1, is far from the luminous device 1. It will be noted that the observer in position P2 may be at the same height as the observer in position P1, but her or his distance d2 is much larger than the distance d1.

As distance increases, the relevant points on the set of Barten curves move to the right. On the right, the contrast sensitivity S of the eye decreases greatly. Thus, the higher the spatial frequency u, the more difficult it will be to distinguish elements inside the luminous device 1, i.e. the less the contrast between the elements inside the luminous device 1 (between the optical module 10 and the mask 15 in particular) will be perceptible by eye.

In position P2, the observer O will be less able to see the elements inside the luminous device 1. Specifically, when the observer O is far from the luminous device 1, the elements inside the luminous device 1 will be smaller in angular size, this corresponding to a higher spatial frequency u, and therefore to a lower contrast sensitivity S.

It will be noted that the set of Barten curves is valid for day or night vision.

Of course, the description of the invention is not limited to the embodiments described above and to the field described above. Thus, in another non-limiting embodiment, when the patterns 130 are punctual patterns, their cross section may be hexagonal in shape, triangular in shape, rectangular in shape, etc. Thus, in one non-limiting embodiment, the luminous device 1 comprises a plurality of optical modules 10.

Thus, the described invention particularly has the following advantages:
it allows the transmittance of the surface 110, 140 of the luminous device 1 to be decreased,
it allows the elements inside the luminous device 1 to be hidden from observation from close by without affecting the optical performance of said at least one luminous function F performed by the luminous device 1,
it is an alternative solution that is less bulky than a mechanical solution using a movable mask,
it is an alternative solution that is cheaper than an electro-optical solution using an LCD screen to occult the light Lx in the off mode of the optical module 10.

What is claimed is:

1. A luminous device for a vehicle, the luminous device being configured to perform at least one luminous function and comprising at least one optical module, an outer lens and a housing containing the at least one optical module, with the luminous device including a textured film covering a surface of the luminous device, the textured film including patterns configured to reduce the transmission of light entering into the luminous device through the surface.

2. The luminous device as claimed in claim 1, wherein the surface is covered in whole or in part by the textured film.

3. The luminous device as claimed in claim 1, wherein the surface is a face of the outer lens.

4. The luminous device as claimed in claim 1, wherein the surface is a face of an intermediate element placed between the optical module and the outer lens.

5. The luminous device as claimed in claim 1, wherein the patterns are surface patterns or volume patterns.

6. The luminous device as claimed in claim 5, wherein the surface patterns are produced using an IML or IMD process.

7. The luminous device as claimed in claim 5, wherein when the patterns are surface patterns, they are formed by an ink deposit with a thickness of between 1 and 10 microns.

8. The luminous device as claimed in claim 1, wherein the patterns are occulting or semi-transparent.

9. The luminous device as claimed in claim 1, further comprising a mask.

10. The luminous device as claimed in claim 1, wherein the luminous function is an illuminating function, a signalling function, a styling luminous function, or an enhanced luminous function.

11. The luminous device as claimed in claim 1, wherein the patterns are continuous lines or punctual patterns.

12. The luminous device as claimed in claim 1, wherein there is a pitch between the patterns and the pitch has a maximum value of 0.8 mm between the center of two patterns.

13. The luminous device as claimed in claim 1, wherein the surface including the textured film is configured to transmit light variably.

14. The luminous device as claimed in claim 1, wherein the patterns are arranged so that there is a variable pitch between the patterns and/or so that the patterns have a variable material density and/or so that the patterns have a variable area.

15. The luminous device as claimed in claim 1, wherein the patterns form a negative image of punctual patterns, the punctual patterns being substantially transparent.

16. The luminous device of claim 15, wherein the surface including the textured film is configured to transmit light variably.

17. The luminous device as claimed in claim 16, wherein the punctual patterns are arranged so that there is a variable pitch between the punctual patterns and/or so that the punctual patterns have a variable area.

18. The luminous device as claimed in claim 17, wherein the negative image comprises different areas with different material densities.
